(19) United States
(12) Patent Application Publication
(10) Pub. No.: US 2002/0032638 A1
(43) Pub. Date: Mar. 14, 2002

(54) Efficient interface for configuring an electronic market

(76) Inventors: Arti Arora, Los Altos, CA (US); Edward Lazear, Portola Valley, CA (US)

Correspondence Address: TOWNSEND AND TOWNSEND AND CREW, TWO EMBARCADERO CENTER, EIGHTH FLOOR, SAN FRANCISCO, CA, 94111-3834, US

(21) Appl. No.: 09/823,239

(22) Filed: Mar. 30, 2001

Related U.S. Application Data
(60) Provisional application No. 60/193,955, filed on Mar. 31, 2000.

(51) Int. Cl. G06F 17/60

(52) U.S. Cl. 705/37

(57) ABSTRACT

An administrator interface for defining or configuring a market via matching engine and corresponding market generation system. The interface includes a first set of instructions that allow an administrator to name and select a market of a certain market type. A second set of instructions allows the administrator to define or configure an attribute of an entity to be transacted in terms of one or more values associated with the attribute. Various possible market types include competitive market, exchange market, barter, reverse auction, consignment store, and trading post. The second set of instructions includes a mechanism for selectively associating an attribute of a product or service to be transacted via the market with a descriptor variable. Another mechanism facilitates configuring properties of the descriptor variable and associates the descriptor variable with one or more importance values. The administrator-specified importance values may be default importance values or seller importance values. Another mechanism lets an administrator define the descriptor variable as being discrete or continuous and enables the selection of an evaluation method for evaluating the descriptor variable during market operation.

### CLAIM OF PRIORITY

This application claims priority from U.S. Provisional Pat. Application No. 60/193,955, filed Mar. 31, 2000, entitled “Electronic Commerce System Including Weighted Characteristic Matching, Dynamic And Automated Creation Of Markets, Analysis Tools And Administrator Interface” which is hereby incorporated by reference as if set forth in full in this document.

### CROSS-REFERENCES TO RELATED APPLICATIONS

This application is related to co-pending Patent Application No. [TBA], filed Mar. 30, 2001, entitled “Electronic Matching Engine For Matching Desired Characteristics With Item Attributes” (Attorney Docket 20512-1-1) and patent application Ser. No. [TBA], filed Mar. 30, 2001 entitled “System And Method For Implementing Electronic Markets” (Attorney Docket 20512-1-2).

### COPYRIGHT NOTICE

A portion of the disclosure recited in this specification contains material which is subject to copyright protection. Specifically, source code and other text that is executable, or functionally interpretable, by a digital processor is included. Tables representing data structures are included. The copyright owner has no objection to the facsimile reproduction of the specification as filed in the Patent and Trademark Office. Otherwise all copyright rights are reserved.

### BACKGROUND OF THE INVENTION

1. Field of Invention:

This invention relates to matching systems. Specifically, present invention relates to systems and methods for configuring and controlling systems, such as e-commerce systems, that match two or more entities in a process according to certain matching criteria.

2. Description of the Related Art:

Systems for matching two or more entities in a transaction are employed in various demanding applications including e-commerce markets and corporate internal allocation applications for matching job assignments to workers. Such applications require efficient systems that can accurately and effectively match two or more entities in a transaction to optimize the compatibility of the match.

Systems for matching entities in a transaction are particularly important in e-commerce market applications, where buyers are matched to products or services they wish to purchase based on certain attributes of the products or services. For example, to accommodate a customer wishing to purchase white running shoes with black tread, an online shoe store may implement a matching system that searches a catalog attempting to find shoes that match the customer's preferences. Existing matching engines and associated e-commerce markets are often based on a categorical approach to matching buyers to products and matching buyers to sellers.

Conventional categorical matching engines for configuring e-commerce markets often lack accompanying interfaces for efficiently configuring or changing market properties in accordance with changing market conditions. In a categorically structured market, each product for sale is associated with a category specified by a certain combination of discrete attributes. For example, in a categorically structured used car exchange market, each car may be categorized according to make, model, year, and color attributes. However, several attributes, such as leather interior, stereo, and sunroof may be of interest to a user. As the number of attributes increases, the number of possible categories becomes excessively large and impractical. A customer is usually limited to a few discrete criteria when searching for products and is forced to decide on these criteria even if the customer has no preference. Furthermore, market generation engines employing the categorical approach generally cannot efficiently configure or generate various different types of markets, such as barter, auction, and reverse auction markets. Existing e-commerce matching systems and associated markets are not easily reconfigured to overcome these inherent shortcomings

Conventional market configuration interfaces and accompanying market generation engines are generally inflexible and not portable to different e-commerce platforms. Consequently, e-commerce markets often require costly redesign for each new application.

Furthermore, market configuration and generation systems often lack sufficient market analysis functionality for allowing administrators to maximize profitability through adjustments to the e-commerce site design. The systems generally do not recommend optimal e-commerce site configurations to maximize market profitability.

Systems and interfaces for efficiently configuring and generating e-commerce markets or internal allocation applications have been slow to develop. Certain e-commerce market capabilities, such as auction, reverse auction, and barter are required for some applications and not required for others. Accordingly, any special requirements are typically met by custom designing and building appropriate systems, which is often expensive and impractical.

Conventionally, e-commerce systems are application-specific, designed according to a certain business model. As the business model changes, corresponding changes to the accompanying e-commerce systems are expensive and time consuming. Often, additional software must be written, or the entire e-commerce system must be redesigned to accommodate changes to the business model.

Hence, a need exists in the art for an efficient system, method, and corresponding streamlined administrator interface for easily and cost-effectively configuring and/or altering an e-commerce system to meet the needs of a given business model or market place.

### SUMMARY OF THE INVENTION

The need in the art is addressed by the efficient administrator interface for defining or configuring a market of the present invention. In the illustrative embodiment, the inventive interface is adapted for use with a matching engine and corresponding market generation system. The interface includes a first set of instructions for allowing an administrator to name and select a market of a certain market type. A second set of instructions allows the administrator to define or configure an attribute, to be used in association with a person, item, or task to be involved in a transaction of the market, in terms of one or more values associated with the attribute.

In a specific embodiment, the second set of instructions varies according to the market type. Market types include competitive market, exchange market, barter, auction, reverse auction, consignment store, and trading post. The second set of instructions includes a mechanism for selectively associating an attribute of a product or service to be transacted via the market with a descriptor variable and mechanism for configuring properties of the descriptor variable. The mechanism for configuring properties of the descriptor variable includes a mechanism for associating the descriptor variable with two importance values. These may be default importance values specified by the administrator importance values specified by the buyer and seller.

In a more specific embodiment, the mechanism for configuring properties of the descriptor variable includes a mechanism for defining the descriptor variable as being discrete or continuous. The second set of instructions further includes a mechanism for selecting an evaluation method for evaluating the descriptor variable during market operation. The evaluation methods include: an equal to method, a not equal to method, a strictly more than method, a strictly less than method, a less than or equal to method, a more than or equal to method, a linear distance method, a quadratic distance method, a logarithmic distance method, a more is better method, a less is better method, a distance - less than method, a distance-more than method, an experience method, and an incumbency method. The second set of instructions further includes a mechanism for selecting a type of input field, such as drop down, text box or check box associated with the descriptor variable for inclusion in a user interface associated with the market. For each descriptor variable defined, there are values specified by the buyers and sellers at market run time. Values can be free form, as in a text box format, or there can be a finite set of values defined in the market configuration. Furthermore, for each descriptor variable defined, there are exactly two importance values, or weights, one from the buyer's perspective and one from the seller's perspective. These importance values can be defined at configuration time by the market administrator, or they can be defined by the buyers and/or sellers at market run time.

The first set of instructions includes a set of system administrator interface input panels. The system administrator interface input panels include one or more input fields for naming a market to be selected or created. One or more input fields are employed to associate the market to be created with a user group of market administrators.

The system administrator interface input panels further include one or more input fields for associating a market administrator with the user group. One or more additional input fields also facilitate copying or deleting an existing market configuration.

The second set of instructions includes a set of market administrator interface input panels. One or more of the market administrator interface panels includes an input field for defining the market in terms of market type, a sub-type of market type. Another input field is used to define the market in terms of transaction type. Other input fields are used to define the market according to whether or not the market will transact entities that are assigned to categories. Additional input fields are used to define the market according to whether or not the market will transact entities based on descriptors.

The novel design of the present invention is facilitated by the second set of instructions, which allow an administrator to efficiently configure a market according to changing demands by adjusting values associated with entities to be transacted via the market. These values affect how entities transacted via the market will be evaluated by the accompanying matching engine used to match buyers with sellers.

The ability to associate transaction entities with continuous values enables various market forms that would otherwise be impossible to generate due to restrictions imposed by hierarchically structured matching engines. The administrator interface of the present invention facilitates switching between various market forms to accommodate changing market demands without the need for additional programming.

In one embodiment the invention provides an administrator interface for defining or configuring a market including a first set of instructions for allowing an administrator to name and select a market; and a second set of instructions for allowing said administrator to configure a set of attributes in a transaction of the market.

### BRIEF DESCRIPTION OF THE DRAWINGS

FIG. 1 is a diagram of a customizable matching system constructed in accordance with the teachings of the present invention.

FIG. 2 is flow diagram of a generalized method for configuring an e-commerce a market via the administrator interface of FIG. 1.

FIG. 3a shows a first set of software-generated system administrator interface panels for implementing the method of FIG. 2 and obtaining input from the system administrator.

FIG. 3b shows a second set of software-generated panels continued from FIG. 3a.

FIG. 4 is a flow diagram of a method employed by the system administrator to configure the customizable matching system of FIG. 1 via the administrator interface panels of FIGS. 3a-3b.

FIG. 5a shows a first set of software-generated market administrator interface panels for implementing the method of FIG. 2 and obtaining input from the market administrator.

FIG. 5b shows a second set of software-generated panels continued from FIG. 5a.

FIG. 5c shows a third set of software-generated panels continued from FIG. 5b.

FIG. 5d shows a fourth set of software-generated panels continued from FIG. 5c.

FIG. 5e shows a fifth set of software-generated panels continued from FIG. 5d.

FIG. 6 is a flow diagram of a method for obtaining requisite input from a market administrator via the market administrator panels of FIG. 5a-5e for use by the method of FIG. 2.

### DESCRIPTION OF THE INVENTION

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

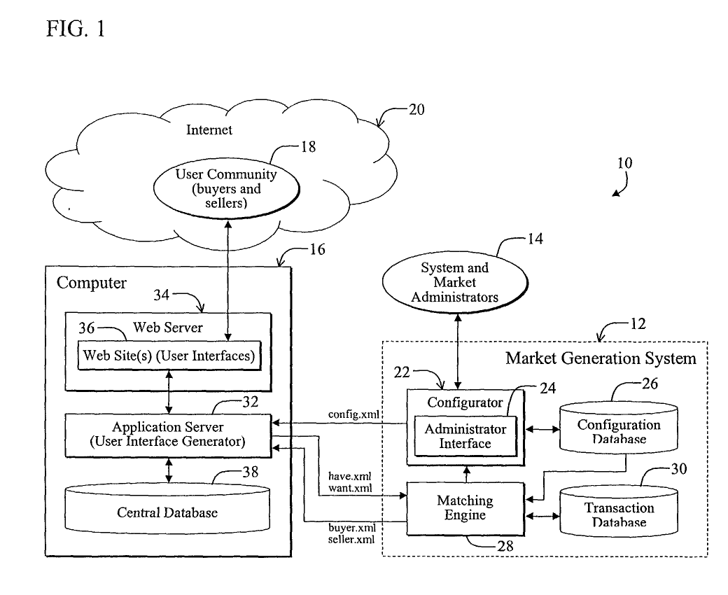

FIG. 1 is a diagram of a customizable matching system 10 constructed in accordance with the teachings of the present invention. For clarity, various components of the matching system 10, such as operating systems, modems, and power supplies are not shown in FIG. 1, however these components are well known and readily implemented by those skilled in the art.

The matching system 10 generates software-facilitated markets by efficiently matching buyers and sellers, matching buyers to products, and/or matching internal tasks to employees, and so on, in accordance with the type(s) of market implemented by the matching system 10. For the purposes of the present discussion, the term market is defined as any system for matching and/or allocating two or more entities in a transaction. A market is typically associated with a physical or virtual location where entities, such as buyers and sellers, are involved in transactions and come together to sell or exchange goods and/or services. Furthermore, in the present discussion, the terms “market” and “market configuration” are used interchangeably. The market configuration represents a computer file (or other memory mechanism) with instructions and data for implementing an electronic market.

The matching system 10 includes a market generation system 12 in communication with system and market administrators 14 and a client computer 16. The client computer 16 communicates with a user community 18, which may include buyers and sellers, via the Internet 20.

The market generation system 12 includes a market configuration are hereby referred to as the “configuration” 22 having an administrator interface 24, a configuration database 26, a matching engine 28, and a transaction database 30. The administrator interface 24 enables market administrators 14 to quickly configure and re-configure the matching system 10 to meet changing market demands.

The administrator interface 24 facilitates creating a user interface implemented via the website 36. The administrator interface 24 has instructions (including administrator instructions and corresponding implementation software) and input fields for facilitating market type definition. The administrator interface 24 also includes instructions and input fields allowing the administrators 14 to define characteristics associated with entities to be transacted via a market, such as products and/or services.

The configurator 22 outputs configuration data to an application server 28 residing on the client computer 16. The configurator 22 also communicates with the configuration database 26, which provides input to a matching engine 28. The matching engine 28 provides intelligence feedback to the configurator 22 and communicates with the transaction database 30 and the application server 32 running on the client computer 16.

The client computer 16 has a web server 34 and a central database 38, which communicate with the application server 32. The web server 34 hosts websites 38, which are accessible to the online user community 18 via possibly the Internet 20.

In operation, a company or other organization wishing to use the matching system 10 to generate an e-commerce market provides the market administrators 14 with a clearly defined business model. Such a company is called a net market maker, which is an entity that creates an electronic market to match buyers and sellers. The net market maker does not necessarily own or provides goods and/or services.

The administrators 14 input market configuration information to the configurator 22 via the administrator interface 24 in accordance with the selected business model. The market configuration information includes the name and type of market to be configured, which administrators and groups thereof will have access to configure the market, and market behavior information and matching criteria. Market behavior information includes selected rules sets to define the sequence of market function as well as the process of qualification and/or matching. Matching criteria includes the attributes of the good and/or services relevant in the matching process, the allowed values for those attributes, the allowed importance values (or weights) for those attributes, the method of evaluating those attributes, and the method of displaying those attributes to buyers and sellers.

Market configuration information that is input via the administrator interface 24 of the configuration 22 is stored in the configuration database 26. The configuration database 26 also stores configuration information for previously created markets, which enables the administrators 14 to run multiple market simultaneously as well as, to selectively copy configuration information from pre-configured markets to expedite market implementation.

In the present specific embodiment, the configuration information that is provided by the market administrators 14 to the configurator 22 via the administrator interface 24 is sent to the application server 32 on the client computer 16 as an XML (Extensible Mark-up Language) file (config.xml) via HTTP (Hypertext Transfer Protocol) protocol. Use of XML files enhances the portability of the market generation system 12, facilitating interfacing with different client computers running different types of application servers, web servers, and operating systems. Communicating configuration data via an xml/http feed provides a dynamic link between the client solution and the market configuration, allowing for quick and seamless modification of the market post-deployment.

The administrators 14 may selectively activate and deactivate markets. When a configured market is activated, the market configuration information is provided to the application server 32 running on the client computer 16. The matching engine 28 receives configuration information from the configuration database 26. In an active market, configuration information is available to the websites 36 so that buyers and sellers 18 can input data. In an inactive market, market configuration is unavailable to the front end, (i.e., websites) 36 so that users, such as buyers and sellers, cannot enter data, and so that administrators can make modifications to the configuration.

The configurator 22 allows administrators 14 to configure a market such that the configuration drives user interfaces 36. Through a series of drop-down menus and questions implemented via panels, the administrators 14 are guided through the process of setting up the particular market. Input from the administrators 14 affects how the matching engine runs 28 and which modules thereof are employed. The configurator 22 implements simple user interfaces 36 via the administrator interface 24 and input received from the administrators 14. The user interfaces 36 incorporate user-friendly questionnaires, and other non-matching questions and content.

The configurator 22 is completely customizable so that the administrators 14 can define any number or type of market descriptor variables. The configurator 22 translates this information automatically into a form (config.xml) that is usable by the client solution 16. Market administrators do not require knowledge of technical implementation details that underlie the operation of the matching engine 28. The configurator 22 automatically handles complex technical issues associated with generating markets, and requires only simple input from the administrators 14. The administrators 14 may only have to complete 4-11 panels.

As discussed more fully below, each of the various software-generated panels employed by the administrator interface 24 are implemented as a screen or window having a header with four primary buttons, which include logout, help, search, and reports menu buttons. The header also includes information regarding each panel and links to different panels. The logout button activates a logout routine to log the administrator out of the system. The help button activates help software for helping the administrator navigate and configure the system. The search button activates searching software that searches for and selects markets based on market name or user group. The reports button activates reporting software that generates reports in three formats, which include configuration reports, transaction results, and transaction entity summary reports. These reports allow the administrators to review market configuration and market effectiveness.

The application server 32 runs software for generating and configuring the user interfaces of the websites 38 interrogating market configuration information (config.xml) received from the configurator 22 with non-matching data, content and questions. The configuration information specifies user interface details, such as what preferences selections for what products or services will be available to the users 18 and how the preferences will be selected by the users 18, such as by drop down lists text fields, or check boxes.

The application server 32 may perform tasks other than user interface generation and configuration without departing from the scope of the present invention. For example, some matching engine computations may be distributed to the application server 32. In general, any software and hardware design or methodology can be used to create an embodiment of the invention. For example, procedural or object-oriented programming techniques can be used. Portions of the processing can be performed on different devices. Any type of communication network or link can be employed. Parallel processing and distributed processing designs can be used. Portions of the processing can be performed by hardware or software, as desired. Any suitable programming languages, databases, tools, application program interfaces, etc., can be used to create a system that embodies the present invention.

When the users 18 participate in the market, they input their preferences (descriptor values and importance values) via the user interfaces of the website 36. Their preferences and selections are forwarded to the matching engine via the application server 32. The pool of matching data housed by the transaction database 30 can be periodically updated by the application server 32 via have.xml and want.xml, two data forms containing preferences and availability of products and/or services. Matching requests initiated by users 18 is communicated to the matching engine 28 via xml formatted requests over http. The match result is then returned, also in xml format, to be interpreted by the application server 32 and presented to the users 18.

The matching engine 28 selectively stores and accesses transaction information on the transaction database 30. The transaction database 30 maintains transaction records, which facilitate market-clearing operations. The administrators 14 may employ the administrator interface 24 to direct the matching engine 28 to clear a market. The market can also be cleared via a command from the application server 32.

The matching engine 28 employs the configuration information to match buyers and sellers, buyers with products or services, or workers with tasks, and so on, according to the configuration information, which may include pre-selected matching techniques.

The matching engine 28 of the present invention may accommodate discrete and continuous methods of comparing buyer and seller attribute preferences. This method of comparison is based on the evaluation rule selected in the configuration (e.g, more is better, equal to, etc. See the table in the Source Code Appendix entitled “ixe_descriptor evaluation” for a complete list). This method of comparison is also based on importance values, either specified individually by buyers and sellers, or globally by the market administrator. The resulting match score for each descriptor is based on the descriptor evaluation and the importance weight. The overall match score for a buyer-seller relationship is a cumulative score of all the attributes. The exact details of the method for computing the matching score are application-specific and may vary. One skilled in the art with access to the present teachings may easily adapt the methods disclosed herein to accommodate the needs of a given application.

The matching engine 18 may be employed to recommend an optimal market for a given combination of goods and services based on previous transaction information stored in the transaction database 30 and based on intelligence algorithms running on the matching engine 28. These intelligence algorithms may also be employed to perform predictive simulations in accordance with varying parameters as set via the administrator interface 24. Furthermore, these software algorithms may be employed to endogenously define a market based on predetermined criteria. When the market generation system 12 endogenously defines a market, the market is automatically configured to meet the needs of a given market place. The market administrators 14 are then freed from various market design and configuration tasks.

In the preferred embodiment, the matching engine computes a matching score (Zᵢⱼ) according to the following equation:

$$\begin{matrix}{Z}_{i j} = \sqrt{{Z}_{i j}^{i} {Z}_{i j}^{j}} or & [ 1 ] \\ {Z}_{i j} = \frac{{Z}_{i j}^{i} + {Z}_{i j}^{5}}{2} & [ 2 ]\end{matrix}$$

where Zᵢⱼⁱ and Zᵢⱼ^{j} are defined similarly according to the following equation:

$${Z}_{i j}^{i} = \sqrt{{[ {\prod }_{r} ( 1 - {a}_{i r} ( 1 - {D}_{i j r} ) ) ]}^{\frac{1}{R}} [ {\sum }_{r} {δ}_{r} ( 1 - {a}_{i r} ( 1 - {D}_{i j r} ) ) ]} , \qquad [ 3 ]$$

where R is the total number of attributes if index aᵢᵣ considered; air is an importance value that the i^{th} buyer attaches to the rth attribute. The r^{th} attribute that is associated with the i^{th} buyer is associated with an attribute variable x^{ir}. When computing Zᵢⱼ^{j} for sellers, aⱼᵣ is an importance value that thejth seller attaches to the r^{th} attribute. The r^{tj} attribute associated with the j^{th} buyer is assigned an attribute variable xⱼᵣ. Dᵢⱼᵣ is a variable with a value between zero and one that changes in accordance with how well a buyer's desires are satisfied by a seller's characteristics of vice versa. Dᵢⱼᵣ is given by one of the following equations:

$$\begin{matrix}{D}_{ijr} = max [ 0 , ( 1 - \frac{{C}_{i j r}}{{C}_{r}^{max}} ) ] , or & [ 5 ] \\ {D}_{ijr} = \frac{{e}^{( 1.946 ( {x}_{ir} - {x}_{jr} ) / {σ}_{r} )}}{1 + {e}^{( 1.946 ( {x}_{ir} - {x}_{jr} ) / {σ}_{r} )}} , or & [ 6 ] \\ {D}_{ijr} = \{ 0 , 1 \} , & [ 7 ]\end{matrix}$$

where the factor 1.946 may be changed or set by an administrator; σ is the standard deviation of the difference between the buyers'desired value and a sellers' offered value;C_{yr} is a non-negative pre-determined value, which may be obtained from a table look-up or other procedure; and Cᵣ^{max} is the maximum tolerable value for Cᵢⱼᵣ is application-specific, and may be determined by one skilled. Cᵢⱼᵣ may be zero, which is often the best value for Cᵢⱼᵣ. For example if Cᵢⱼᵣ is defined as the distance between two locations, where Cᵣ^{max} is the maximum tolerable distance. All values greater than Crmax would result in Dᵢⱼᵣ=0. With access to the present teachings, one skilled in the art may easily determine values for Cᵢⱼᵣ and Cᵣ^{max} to meet the needs of a given application. Many of these variables can be defined by the market administrator in the descriptors panel, the continuous values panel, and the market parameters panel. Alternatively, they can be defined in other ways, such as in other panels, automatically by an optimization process, etc.

By scoring matches and allowing users, such as buyers, to assign continuous values and importance weights to preferred product attributes, users may specify or rank varying degrees of preferences between attributes. By computing a total score for the match from both sides, and selecting the match with the best score, situations wherein no matches are returned are eliminated.

In a symmetric exchange market, searched items are scored according to the preferences of the buyer and the seller. The score for a particular item incorporates both buyer and seller preferences, which are indicated via weights or importance weights associated with descriptors only and/or descriptors and descriptor values. A combined score for a particular item is computed via one or more predetermined functions, such as a geometric mean (1) or arithmetic mean (2).

This eliminates a primary shortcoming with conventional matching engines and accompanying systems. Namely, in previous systems buyers were limited to a few product attribute preference selections, such as color, model, and year. Each preference was associated with a discrete value, such as yes or no. The total score for a match between a product and a buyer's preferences was computed as either yes or no. Consequently as the number of possible preferences increased, the likelihood of the system returning no matches greatly increased, and accompanying databases became large and impractical. By employing only discrete weights (1 or 0; yes or no) and failing to allow a consumer to rank relative preferences between attributes, conventional matching engines inaccurately modeled the true preferences or desires of the buyers and resulted in systems which were difficult or impractical to implement.

The matching system 10 may include additional modules, such as market/user level personalization modules, pricing modules, and ramp-up modules, without departing from the scope of the present invention. Such modules, and additional details of the matching engine 28, are discussed more fully in an alternative embodiment of the matching system 10 disclosed in co-pending U.S. Pat. application Ser. No. {TBA], filed Mar.30, 2001, by A. Arora, et al., entitled “Electronic Matching Engine For Matching Desired Characteristics With Item Attributes,” (Atty. Docket No. 20512-000110 US), assigned to the assignee of the present invention and incorporated by reference herein.

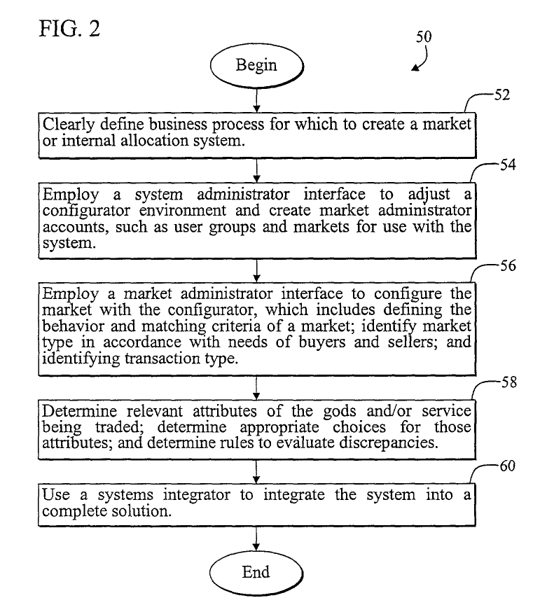

FIG. 2 is flow diagram of a generalized method 50 for configuring an e-commerce market via the administrator interface 24 FIG. 1. In an initial market-conceptualization step 52, a company or other organization wishing to run an electronic market develops a clearly defined business model or process for which to create a market. The conceptualization step 52 involves identifying a viable market for a given combination of products and services via input received from and buyers and sellers regarding the products and/or services. Possible markets in the present embodiment include exchange, competitive market, modified competitive market, consignment store, barter, pawnshop, trading post, qualified auction, futures and credit, and internal allocation markets. These markets are described in the related patent application entitled “System And Method For Implementing Electronic Markets,” referenced above. An indication of the types of markets that can be created with the a preferred embodiment of the present invention are revealed in the ixe_transaction_type table in the Source Code Appendix, and in the related tables.

In a subsequent system administrator step 54, a system administrator employs the administrator interface 24 of FIG. 1 to adjust the configurator environment by creating markets, deleting markets, cloning markets, creating market administrator accounts, organizing market administrators into logical groups, creating user groups, (i.e., groups of administrator accounts, and/or deleting the user groups). The system administrator prepares the configurator for use by market administrators.

Subsequently, in a market administrator step 56, a market administrator employs the administrator interface 24 to further configure a market in preparation implementation by the customizable matching system 10 of FIG. 1. The efficient administrator interface 24 enables the market administrator to manually clear a market, schedule a market to clear automatically, adjust the behavior of the market clearing process by editing configuration parameters of the market, create and run reports depicting market performance or behavior, and/or allow or disallow a market to clear by activating or deactivating a market.

In a subsequent attribute step 58, the market administrator determines attributes of goods and/or services to associate with preferences, which are characterized by descriptors. Each entity transacted in the market is associated with a set of descriptors. When a user, such as a buyer searches for an item, they may enter a descriptor indicating their preference and value to assign a weight or descriptor value to the descriptor. The manner by which the user assigns the importance value, such as by a drop down menu or by an input text field, is controlled by the market administrator via the administrator interface 24 of FIG. 1.

The description value specified by buyers and sellers to attributes are either continuous or discrete variables, as predetermined by the market administrator. For the purposes of the present discussion, a discrete descriptor is evaluated such that the resulting score is either 0 (no match) or 1 (match). Conversely, a continuous descriptor is evaluated such that the resulting score can be any value between 0 and 1, inclusive. This evaluation is further modified based on the specified importance value, which gives the score a weight relative to other descriptors.

After the market administrator sets appropriate parameters that affect how entities in involved in the market will be matched, the market may be ready for activation. In a final implementation step 60, the market administrator activates the market, and appropriate user interfaces are generated via the matching system 10. A systems integrator integrates the market operations into the predefined business model or process for which the market was configured to accommodate.

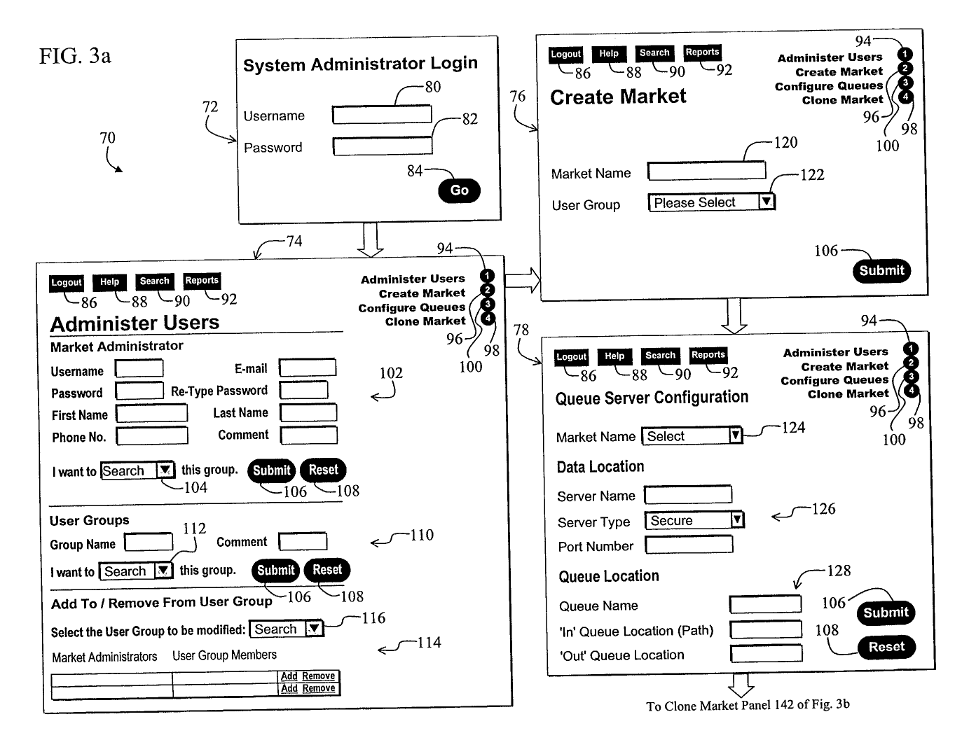

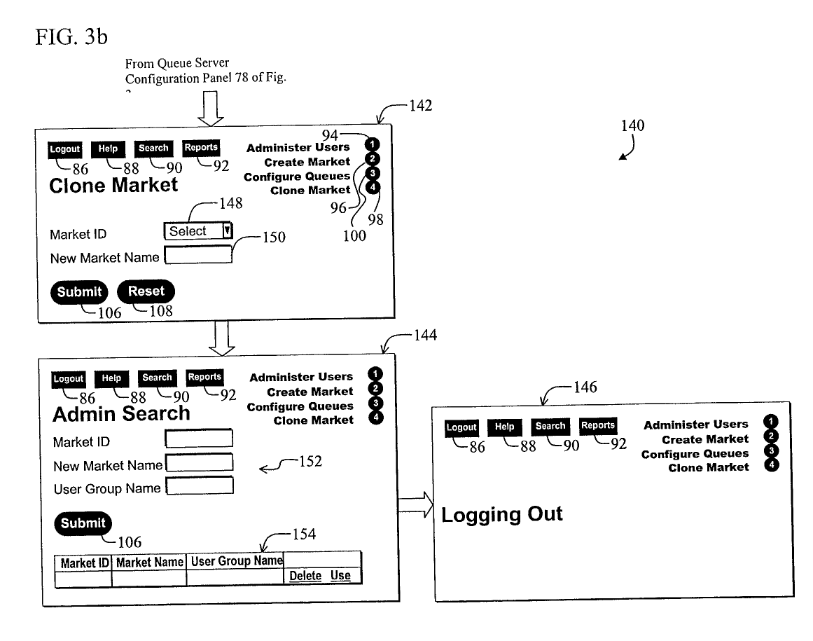

FIG. 3a shows a first set of software-generated system administrator interface panels 70 for implementing the method 50 of FIG. 2 and obtaining input from the system administrator. The panels 70 include a system administrator login panel 72, an administer users panel 74, and a create market panel 76, and a queue server.

The system administrator login panel 72 includes a usename field 80, a password field 82, and a go button 84. After the system administrator enters a usemame and password and presses the go button 84, the system administrator is logged into the system, and the administer users panel 74 is displayed.

All system administrator panels, other than the system administrator login panel 72 have a logout button 86, a help button 88, a search button 90, a reports button 92 near the top left of the panel, and an administer users button 94, a create market button 96, a configure queues button, and a clone market button 100 near the right of the panel.

When the buttons 72-100 are pressed, they activate corresponding panels having substantially similar names.

The system administrator may employ the various buttons 86-100 to display and access corresponding panels or windows in any particular sequence. During the present discussion, various administrator interface panels are ordered according to preferred sequence for a specific embodiment. However, one skilled in the art will appreciate that order by which the panels are actually displayed by a system administrator may vary without departing from the scope of the present invention.

The administer users panel 74 includes a market administrator information section 102, wherein information pertaining to a particular market administrator is entered to create a market administrator account. The information includes login usemame, email, password, first name, last name, phone number, and comment information. The market administrator information section 102 also includes an option menu 104 for allowing the system administrator to search for any market administrator accounts matching the information entered in the information section 102. The option menu 104 also includes the option to add (not shown) the market administrator account information, and an option to remove (not shown) pre-existing account information corresponding to a market administrator. Generally, if a similar market administrator account already exists, it cannot be added.

The system administrator may submit or reset the market administrator information by pressing a submit button 106 or a reset button 108, respectively, in the information section 102. When the submit button 106 is pressed, the action selected in the option menu 104 of the information section 102 is performed. More or fewer options may be added to the option menu 104 without departing from the scope of the present invention.

The administer users panel 74 also includes a user groups section 110 for performing operations on a user group named in the user group section 110 (group of administrators). The user group section 110 includes a user group option menu 112 that includes options for searching, modifying, deleting, and creating user groups. After the desired option is selected by a system administrator, the corresponding task is implemented by pressing the submit button. The user group section 110 may be reset by pressing the corresponding reset button 108.

The administer users panel 74 further includes an add to/remove from user group section 114 with fields for selectively removing or adding market administrator account information from user groups. The user group to be modified is selected via a selection menu 116. Market administrators and/or other user group members are listed next to an option to remove or add. Market administrators are added to or removed from the selected user group by selecting the listed market administrator (such as by highlighting the market administrator's name via a computer mouse) and selecting add or selecting remove, respectively.

The use of market administrator user groups facilitates resource allocation in companies employing the efficient matching system 10 of FIG. 1 to implement several markets or a single complicated market. Different user groups may be assigned to control the configuration of different markets or different aspects of a complicated market employed by the company.

When the market administrator completes the administer users panel 74, the create market panel 76 is displayed. Alternatively, the create market panel 76 may be displayed by pressing the create market button 96 on another panel. The create market panel includes a name field 120 for naming a market to be created and a group assignment field 122 for assigning the market to a user group. The create market panel 74 includes the submit button 106. When the market name and user group are selected, and the submit button 106 is pressed, a corresponding market, i.e., market configuration file is created.

FIG. 3b shows a second set of software-generated system administrator panels continued from FIG. 3a. After the queue server configuration panel 78 of FIG. 3a is displayed, a second set of system administrator panels 140 is displayed. Initially, a clone market panel 142, a search panel 144, then a logout panel 146 are displayed.

The clone market panel 142 includes a market identification field 148 and a new market name field, for identifying a market to be cloned and naming the cloned market, respectively. Identification information pertaining to the market to be cloned and the market to be created may be reset by pressing the reset button 108. Alternatively, pressing the submit button 106 activates the cloning process, which copies the configuration file associated with the market specified in the market identification field 148 and names it according to the name specified in the new market name field 150.

Subsequently, the search panel 144 is displayed. The search panel 144 includes searchable fields 152, which allow the system administrator to search for a market or markets according to market identification number, market name, and/or the name of a user group associated with the market. After the system administrator enters market identification number, market name, and/or user group name via the searchable fields 152, the submit button 106 is pressed. When the submit button 106 is pressed, any markets matching the search criteria are listed in a market list 154. The market list 154 displays market identification, name, and user group name associated with the market and provides options to delete or use the found market(s).

In the present specific embodiment, after completion of the search panel 144, the system administrator has completed market configuration tasks to be completed by the system administrator, and a logout screen 146 is displayed indicating that the system administrator is logging out. The system administrator may logout from any panel other than the system administrator login panel 72 of FIG. 3a by pressing the logout button 86. The system administrator may also generate reports and access help menus by pressing the reports button 92 or the help button 88, respectively from the panels.

When the system administrator completes the panels 72-78 and 142-146 of FIGS. 3a and 3b, one or more market administrators continues with configuring the market matching system of FIG. 1 via the administrator interface 24.

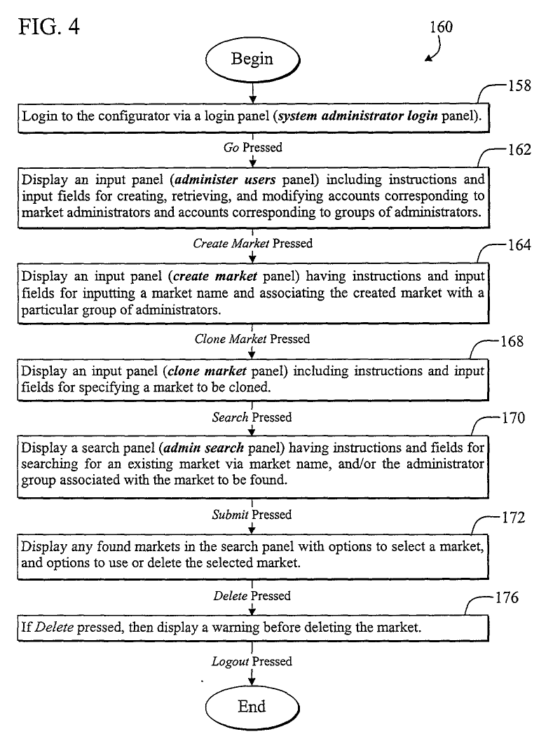

FIG. 4 is a flow diagram of a method 160 employed by the system administrator to configure the customizable matching system 10 of FIG. 1 via the administrator interface panels 72-78 and 142-146 of FIGS. 3a-3b.

In an initial login step 158, the system administrator logs into the system by entering and submitting a valid system administrator name and corresponding password. Subsequently, in a system administrator users step 162, a first input panel is displayed, which includes instructions and input fields for creating, retrieving, and modifying accounts corresponding to market administrators and accounts corresponding to groups of administrators (user groups). After submitting information in the input panel or selecting a create market option, control is passed to a create market step 164.

In the create market step 164, a second input panel is displayed, which includes instructions and input fields for selecting a market and associating the selected market with a particular group of administrators.

In the clone step 168, a fourth panel is displayed, which includes instructions and fields for searching for an existing market via market identification, market name, or the administrator group associated with the market to be found. After submitting the information of the fourth panel, and cloning any desired markets, or after selecting a search option, control is passed to a search step 170.

In the searching step 170 a fifth panel is displayed, which includes instructions and fields for searching for an existing market via market identification, market name, and/or the administrator group associated with the market to be found. After entering the search criteria and selecting submit option, control is passed to a display step 172.

In the display step, any markets found based on the search criteria entered in the fifth panel of the search step 170 are listed in the fifth panel along with options to use or delete each listed market. When the system administrator selects an option to use a listed market or generate a report for the listed market, control is passed to a summary step 174, wherein a high-level summary of properties and data of the market is displayed, and the method 160 is complete. When the system administrator selects an option to delete a selected market, a warning is displayed before deleting the market, and the method 160 is complete.

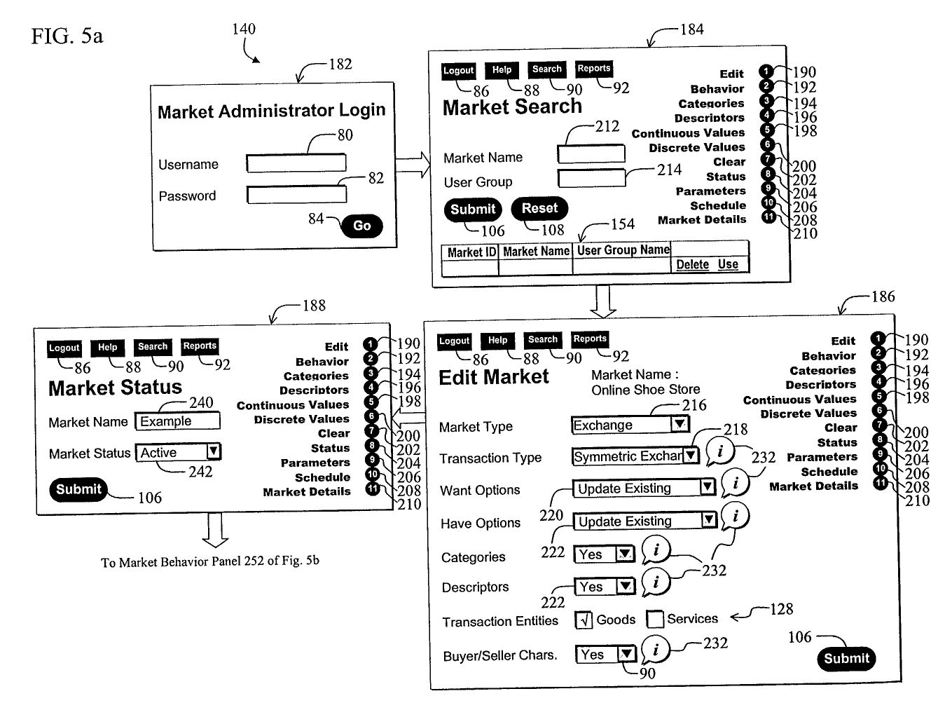

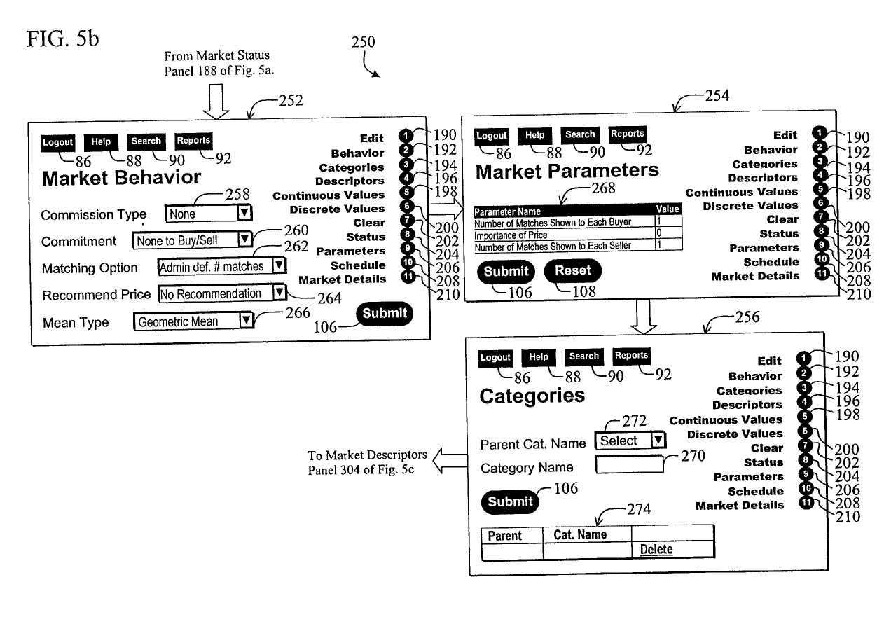

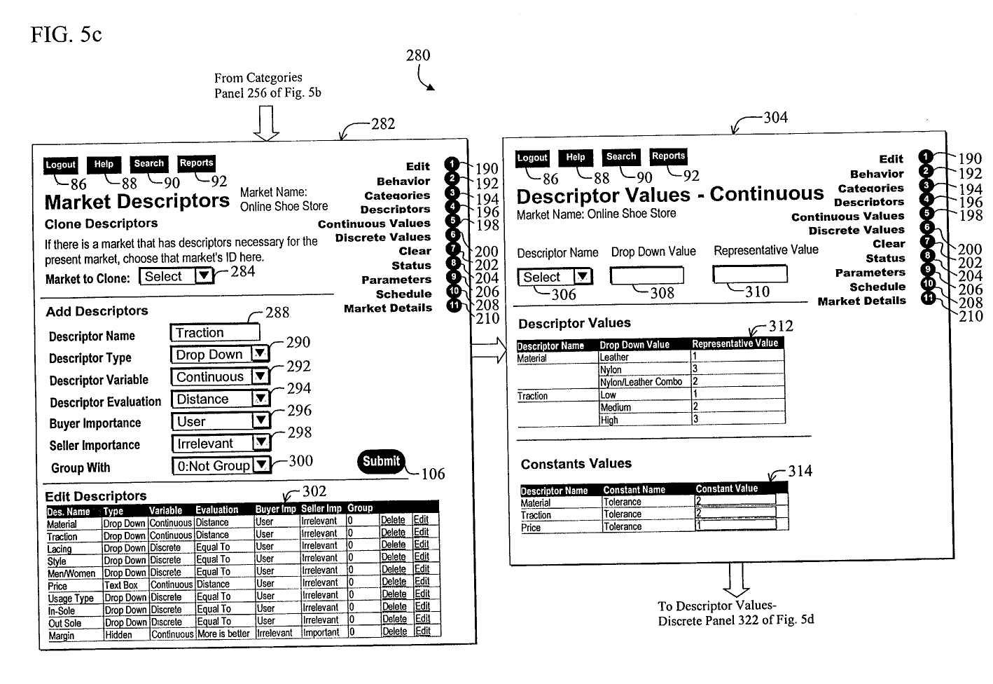

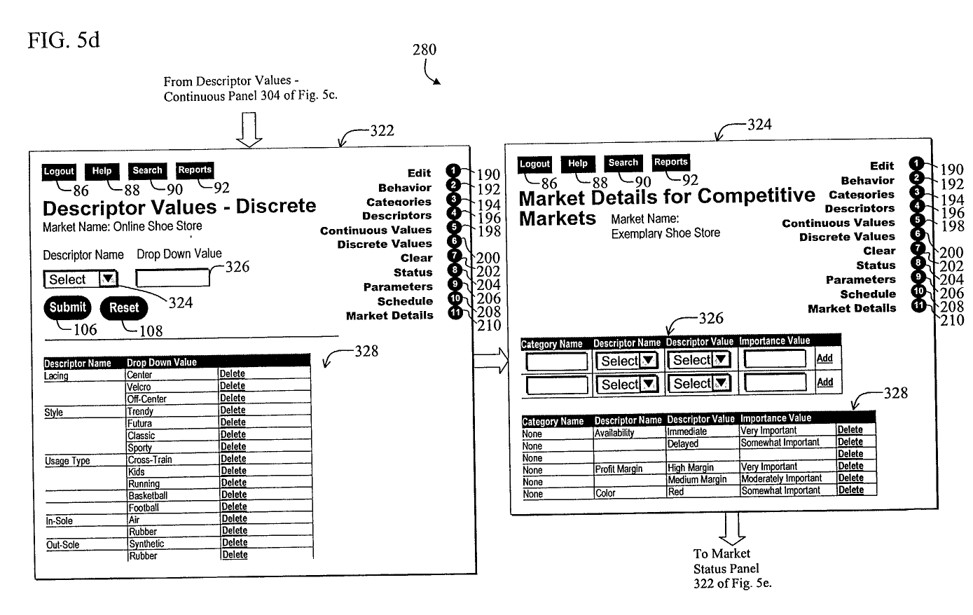

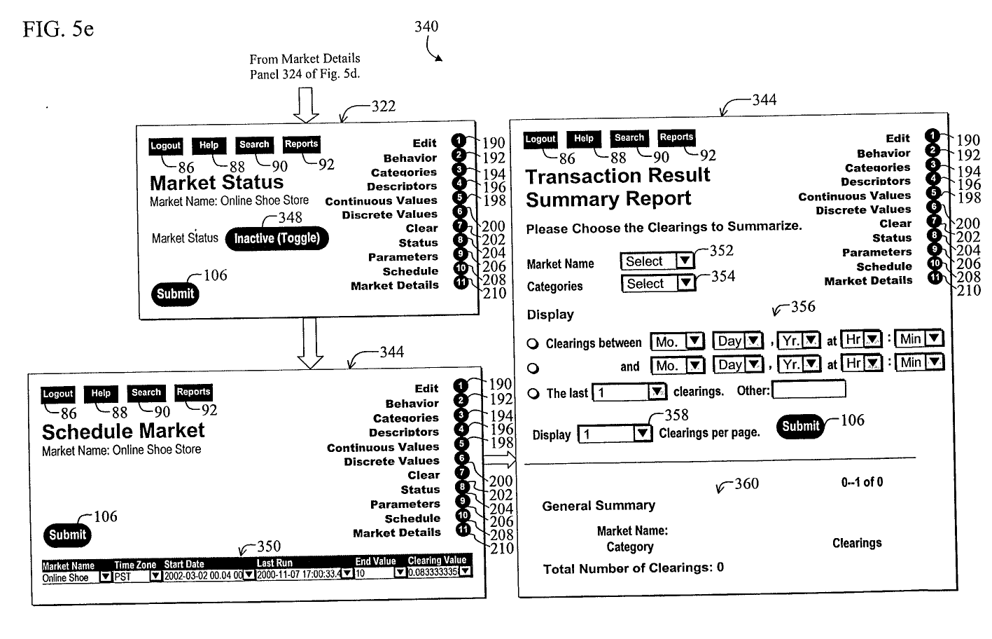

FIG. 5a shows a first set of software-generated market administrator interface panels 180 for implementing the method 50 of FIG. 2 and obtaining input from the market administrator. Although the panels of FIGS. 5a-5e are discussed in a particular order, the order of the panels may vary, and various panels may be omitted without departing from the scope of the present invention. One skilled in the art will appreciate that some panels may be required for certain applications and not required for others. Furthermore, the content and capabilities of each panel may be swapped and interchanged to meet the needs of a given application without departing from the scope of the present invention.

The market administrator interface panels 180 include in part a market administrator login panel 182, a market search panel 184, an edit market panel 186, and a market status panel 188. The market administrator login panel includes usemame and password fields 80 and 82, respectively, and a go button 84. The market administrator enters a usemame and password in the fields 80 and 82, then presses the go button 84 to login. Subsequently, the market search panel 184 is displayed. The market search panel 184 may also be displayed by pressing the search button 90 near the top left of the panel.

Market administrator panels, with the exception of the market administrator login panel 182, include the logout button 86, the help button 88, the search button 90, and the reports button 92 near the top left of the panel. The panels also include an edit button 190, a behavior button 192, a categories button 194, a descriptors button 196, a continuous values button 198, a discrete values button 200, a clear button 202, a status button 204, a parameters button 206, a schedule button 208, and a market details button 210. When any button 190-210 is pressed, it activates a corresponding panel having a substantially similar name. The buttons are different colors based on their completion and availability status as given in Table 1 below.

TABLE 1

| Button Color: | Button Color Indicates: |
|---|---|
| Blue | Current panel. |
| Red | Not visited. |
| Yellow | Visited and incomplete. |
| Green | Completed. |
| Gray | Unavailable, i.e., not required for the current market. |

The market search panel 184 includes a market name field 212 and a user group name field 214. The market administrator may search for a market based on the name field 212 and/or the group name field 214. If the market administrator enters the market name and not the user group, and presses the submit button 106, the configurator 22 of FIG. 1 searches the configuration database 26 to find the appropriate configuration corresponding to the searched market having the specified name. Similarly, if the market administrator enters only the user group name, a search for all markets associated with the specified user group is performed. All markets available to the user are displayed by default. Any found market(s) are then listed (list not shown) in the market search panel along with an option to use the found market. If the market administrator presses the reset button 108, contents of the fields 212 and 214 are reset. After the market administrator finds a particular market and selects the option to use the market or presses the edit button 190, the edit market panel 186 is displayed.

The edit market panel 186 allows a market administrator to define or modify the high-level behavior of a currently inactive market, including specifying the type of market trading structure, whether goods and/or services will be transacted, and whether categories and/or descriptors will be used to characterize entities to be transacted via the market. The edit market panel 186 includes a market type field 216 for specifying market type, a transaction type field 218 for specifying types of transactions to used by the market, a want options field 220 for specifying want options (such as add new data, update existing data, and so on), a have options field 222 for specifying have options, a categories field 224 for indicating whether categories will be employed by the market, a descriptors field 226 for specifying if attribute descriptors will be employed by the market, transaction entities fields 28 for specifying whether goods and/or services will be transacted via the market, and a buyer/seller characteristics field 230 for indicating whether buyer and/or seller characteristics will be employed in the market matching process implemented by the customizable matching system 10 of FIG. 1. The buyer/seller characteristics field 230 enables the inclusion of additional attributes covering characteristics of the buyer that is trading in addition to the characteristics of the items being traded.

The market type field 216 is implemented as a drop down menu wherein the market administrator may select one of several market types. In the present embodiment, the market types include competitive market, exchange market, barter, auction, reverse auction, consignment store, trading post, and various others. See table “ixe-market types.” These market types and corresponding transaction types are discussed more fully in co-pending U.S. Pat. Application No.[TBA], filed Mar.30, 2001, by A. Arora, et al., entitled “System And Method For Implementing Electronic Markets,” (Atty. Docket No. 20512-000110US), assigned to the assignee of the present invention and incorporated by reference herein.

The transaction type field 218 is implemented as a drop down menu wherein the market administrator may select one of several transaction types. The transaction types include competitive, symmetric exchange, internal allocation exchange, department store exchange, custom auction, Dutch auction, and so on, corresponding to the various market types. See ixe_transaction_type table and related tables.

The want options field 220 and the have options field 222 are also implemented as drop down menus, wherein the market administrator may specify have and want options, such as add new data, and update existing data.

If the market administrator selects ‘yes’ in the categories field 224, then the resulting market will be structured to allow categorization of products, or other entities to be transacted, into specific categories. For example, in an online shoe store, categories may be employed to organize shoes according to “Mens,” “Womens,” “Kids,” etc. Categories represent segments of a market that share a common market behavior (as specified in a market behavior panel discussed more fully below) and structure but are cleared independently. Categories are often appropriate in instances where the market community is logically divisible into sub-markets.

If the market administrator selects ‘yes’ in the descriptors field 224, then entities to be transacted in the resulting market will be described according to a set of descriptors assigned to each transacted entity and will not necessarily employ categories in addition. In the online shoe store example, descriptors might include shoe material type, lacing style, price, and so on.

Various fields 218, 220, 224, 226, and 230 have adjacent callouts 232, which when selected activate context-sensitive help screens (not shown).

In the edit market panel 186, selections for an exemplary online shoe store are shown. The online shoe store is chosen as an exchange market that will employ the symmetric exchange transaction type. The want options and have options are set to update existing data. Categories are not employed, but descriptors are. Transaction entities are set to goods, and buyer and seller characteristics are employed in the matching process. Selecting the market type and transaction type as competitive types enables the display of a market details screen, as discussed more fully below. However, the online shoe store is preferably an exchange market employing symmetric exchange transaction types.

Exchange markets are well suited to markets wherein entities being transacted, i.e., traded, are idiosyncratic (each entity is potentially unique) and wherein the search or matching process must account for attributes other than price. Symmetric exchange transaction types are commonly selected when both sides of the market (buyers and sellers) have preferences across attributes, and the final match score weighs each side of the market. For example, many procurement exchanges are non-symmetric, biased towards the buyer. Markets implementing symmetric exchange transactions may accommodate buyer and seller objectives into the matching process. Other market types (auctions, competitive markets, etc.) follow equally detailed structures.

FIG. 5b shows a second set of software-generated market administrator panels 250 continued from FIG. 5a. The second set of software-generated panels 250 includes a market behavior panel 252, a market parameters panel 254, and a categories panel 256.

The market behavior panel 252 allows a market administrator to select specific matching and pricing rules for a given transaction type. The fields in the market behavior panel 252 vary according to input (market type and transaction type) provided to the edit market panel 186 of FIG. 5a. Those skilled in the art will appreciate that various input fields may be added or removed from the market behavior panel 252 to meet the needs of a given application without departing from the scope of the present invention. Fields shown in the market behavior panel 252 and associated market behavior options are dynamically selected by configurator software from hundreds of possible options based on input from the edit market panel 186 of FIG. 5a.

For a symmetric exchange, as in the online shoe store example, the market behavior panel 252 includes a commission type drop down menu 258 for specifying whether commissions will be computed based on each transaction, and if so, what types of commissions will be computed. In the present online shoe store example, no commissions will be employed, since the online shoe store will be a product recommendation site only. In a market wherein a match between an item and a buyer or seller represents a commitment to buy or sell, the same item is made unavailable to other buyers simultaneously.

A commitment drop down menu 260 allows the market administrator to specify if and what type of commitment will be made to buy and sell products. In the present online shoe store example, no commitments to buy and sell will be made, since the online shoe store is a recommendation-only market.

A matching option drop down menu 262 allows the market administrator to select matching options, such as defining the number of matches that will be displayed to a buyer. In the present online shoe store example, the number of matches is set to an administrator-defined number of matches. With reference to FIG. 1, this allows the market maker to control the number of matches shown to each buyer via the market behavior panel 24 and the market parameters panel. Alternatively, the market maker may control the number of matches shown through an interface of the website 36. Alternatively, the matching option may be set to a user defined number of matches, which results in the display of a corresponding option to the users 18 via the website 36 of FIG. 1. Alternatively, the matching option may be set to an automatically defined number of matches, wherein the matching engine 28 automatically selects the number of matches to be displayed based on predetermined rules incorporated in the design of the matching engine 28 of FIG. 1.

The market behavior panel 252 also includes a price recommendation drop down menu 264 and a mean type drop down menu 266. The price recommendation drop down menu 264 allows the administrator to select whether and if so, what type of price recommendation will be provided to market participants. In the present online shoe store example, no price recommendations are employed, since the shoe store will not dynamically price each shoe based on its configuration or based on supply and demand. The market is set up to not recommend prices. Instead, prices are read from a catalog and treated like other attributes.

The mean type drop down menu 266 allows a market administrator to select if and what type of computation will be employed to compute a mean score once a score is determined for both sides of the market. In the present example, the mean computation is selected as a geometric mean computation. The complete list of Market Behaviors is included in the table labeled “ixe_market_behaviors”.

Subsequently, a market parameters panel 254 is displayed. The market parameters panel 254 enables a market administrator to set parameters according to selections made in the market behavior panel 252. Depending on the selections made in the market behavior panel 252 some parameters or no parameters may require setting. In the present specific embodiment, parameters are listed in a parameter table 268 along with adjacent editable values. Parameters may include values corresponding a weight of a demand price, the number of matches shown to each buyer, the importance of price, the number of matches shown to each seller, and so on. For example, in a certain an exchange market, a price recommendation parameter may specify a weight that is involved in a weighted average calculation of bid and ask prices used to recommend a price for a certain item. The complete list of Market Parameters is included in the table labeled “ixe_market_behavior_params”.

A market administrator may edit the values in the table and then submit them to the configuration database by pressing the submit button 106. The reset button 108 resets the parameter values to their original default state. Different input mechanisms, such as mechanisms other than the table 268, may be employed in the panels of the present invention without departing from the scope thereof.

The categories panel 256 is displayed only for markets that have been set to accept certain categorical structuring in the categories drop down menu 224 of the edit market panel 186 of FIG. 5a. The categories panel 256, if available, is displayed after pressing the submit button 106 from the market parameters panel 254 or after pressing the categories button 194 from any panel displaying the categories button 194.

The categories panel 256 has a category name field 270 and a parent category selection menu 272. The market administrator may name a category and categorize it under a parent category via the fields 270 and 272, respectively. Categories and associated parent categories are listed, along with an option to delete or add each category, in a category table 274. The category table 274 may be omitted without departing from the scope of the present invention. Subsequently, a market descriptors panel is displayed as discussed more fully below.

FIG. 5c shows a third set of software-generated market administrator panels 280 continued from FIG. 5b. The third set of software-generated panels 280 includes a market descriptors panel 282 and a continuous descriptor values panel 304.

The market descriptors panel 282 allows a market administrator to associate attributes of entities to be transacted with descriptors; to specify the name, type, and operation of the descriptors and associated values; to copy and edit existing descriptors or create custom descriptors; to assign buyer and seller importance weights to descriptors; and allows the market administrator to associate the descriptors to a group.

The market descriptors panel 282 includes a clone descriptors section with a market-to-clone field 284. The market-to-clone field 284 allows the market administrator to select a market from which to copy existing descriptors and descriptor values to the current market. For the purposes of the present discussion, the terms descriptor and descriptor variable are used interchangeably.

An odd descriptors section 286 includes a descriptor name field 288, a descriptor type field 290, a descriptor variable field 292, a descriptor evaluation field 294, a buyer importance field 296, a seller importance field 298, and a group field 300. To create a descriptor, the market administrator enters a descriptor name in the descriptor name field 288 and selects appropriate options in the remaining fields 290-300 of the custom descriptors section 286. After submitting the descriptor information by pressing the submit button 106, the descriptor is displayed in a descriptors table 302. The descriptors table 302 lists descriptors by name, type, evaluation method, buyer importance option, seller importance option, and group. The options to edit or delete a descriptor is also provided in the table adjacent to each descriptor.

The type of the named descriptor is selected via the descriptor type field 290, which is implemented as a drop down menu having a drop down menu option a text box option and a checkbox option. With reference to FIGS. 1 and 5c, when the market administrator selects the drop down option, the buyers and sellers of the user community 18 are shown a drop down menu, via the user interfaces of the website 36, when indicating their preferences for a particular descriptor, such as shoe traction or shoe price. The descriptor drop down menu appearing on the user interfaces of the web site 36 for a particular descriptor includes various descriptor values that may be associated with the descriptor. For example, a traction descriptor for an online shoe store may employ leather, nylon, or rubber as descriptor values. Each descriptor is assigned preference weights, called importance values, for both the buyer and the seller. These weights can be specified in the user interfaces 36, or by the administrator. When the market administrator selects the text box option via the descriptor type field 290, a text box is employed to allow a user to enter descriptor values. The checkbox descriptor type allows for checked or unchecked

In a specific embodiment, the selection of a text box in the field 290 causes a text box to appear as an input field next to the corresponding descriptor in the user interface 36 of FIG. 1. The user may enter a series of descriptor values in a given order.

The market administrator establishes whether the descriptor specified in the descriptor name field 288 is continuous or discrete by selecting the appropriate option in the drop down menu of the descriptor variable field 292. Discrete descriptors provide users, such as buyers and sellers, specific options (descriptor values) which are evaluated as matching or not matching. Discrete descriptors represent Boolean conditions, meaning that buyers and sellers and/or buyers and products either perfectly match with the descriptor or not at all. Continuous descriptors are evaluated on a continuum such that buyers and sellers and/or buyers and products may match less than 100% and greater than 0%. Continuous descriptors are associated with representative values as discussed more fully below.

The descriptor evaluation field 294 is a drop down menu for indicating how the named descriptor will be evaluated by the matching engine 28 of FIG. 1 to score a match. Descriptor evaluation options include equal to, not equal to, strictly less than, strictly more than, less than or equal to, more than or equal to, distance, more is better (only available for continuous descriptors), and less is better (only available for continuous descriptors). (Please refer to the table “ixe.descriptor evaluation.”) The evaluation methods compare buyer and seller descriptor values and check for the corresponding conditions. For example, if the evaluation method for a continuous descriptor is the linear distance method, then the match score for the descriptor decreases linearly based on the distance (difference in values) between the desired attribute level from the buyer's perspective and the attribute level from the seller's perspective. For discrete variables, the equal to (=) evaluation option is selected in the descriptor evaluation field 294. Other types of evaluation operations are listed in association with the ixe_descriptor_evaluation table and associated data in the Source Code Appendix. In general, any suitable type of evaluation computation or methodology can be used.

The buyer importance field 296 is implemented as a drop down menu and includes options for specifying whether the buyer should input how important this descriptor is to the buyer (by inputting a specific importance value). Alternatively, “User defined” can be selected from the drop down menu, allowing each buyer and/or seller to individually provide their importance value for the given descriptor. In the present example, the “user defined” option is selected in buyer importance field 296 for the traction descriptor. Consequently, the buyer can then assign an importance value to this descriptor.

The seller importance field 298 follows the same logic. In the present example, the seller importance value is set to irrelevant. The group number for this descriptor is set to 0 in the group field 300, which indicates that the traction descriptor does not need to be grouped with another descriptor. A non-zero value can be used to indicate that the descriptor belongs to a particular group (as designated by the group number). Grouping descriptors allows them to be evaluated together. For example, one could have two descriptors, “Job Category” and “Years in Job”, that only make sense when evaluated together. By placing them in the same group, the matching engine will evaluate them as a set.

Subsequently, the continuous descriptor values panel 304 is displayed. The continuous descriptor values panel 304 is not available if no continuous descriptors exist for the current market. The continuous descriptor values panel 304 is accessed by pressing the continuous values button 198 from another panel. The continuous descriptor values panel 304 includes a descriptor name drop down menu 306 for selecting a descriptor, a drop down value text field 308 for specifying drop down options to be included in user interface of the website 36 of FIG. 1, and a representative value field 310 for specifying a representative value for the descriptor drop down value.

A descriptor values table 312 lists the descriptor variable name along with drop down values associated with the descriptor variable and representative values associated with the drop down values of the descriptor variable. All variables that are set up as continuous and drop down need values to be associated with the drop down menus. Furthermore, the matching engine 28 of FIG. 1 prefers that each continuous descriptor drop down value be associated with a representative value. Representative Values are provided to the matching engine in order to relate different descriptor values on a continuum. To use the example of shoe traction, if the drop down values are Low, Medium, and High, the engine has no way of knowing that Medium is closer to High than Low is. By providing representative numeric values, the engine can then calculate mathematical differences and determine an appropriate score, such that if a buyer prefers a shoe will high traction (representative value =3.0), a shoe with Medium traction (representative value =2.0) should receive a higher score than a shoe with Low traction (representative value =1.0). Exemplary representative values for the material and traction descriptor variables and their corresponding drop down values are given in the descriptor values table 312.

A constants values table 314 in the continuous values panel 304 lists values of any constants that are required by the matching engine 28 of FIG. 10 to compute a match between each buyer and seller. In the shoe example, tolerance constants and corresponding values are employed, although a larger range of constants exist. See table “ixe-descriptor constants.” The values assigned to the constants in the table 314 are editable. The tolerance constants in the present example are specific to continues descriptors evaluated according to the linear distance method. The tolerance constants specify cut-off values beyond which the market administrator no longer wants to decrease the score in a continuous fashion.

If any discrete descriptors are employed, then a discrete descriptor values panel may be displayed by pressing the discrete values button 200, as discussed more fully below.

FIG. 5d shows a fourth set of software-generated panels 320 continued from FIG. 5c. The fourth set of software-generated panels 320 includes a discrete values panel 322 and a market details panel 324.

The discrete values panel 322 allows the market administrator to assign drop down values to discrete descriptor variables and to delete the drop down descriptor values. The discrete values panel 322 includes a discrete descriptor drop down selection menu 324 for selecting a discrete descriptor, and a drop down value field 326 for assigning a drop down value to the discrete descriptor. Because discrete descriptors are evaluated on a Match/No Match algorithm, no representative value is required. The submit button 106 is used to complete the assignment. The reset button resets the fields 324 and 326. The discrete values panel 322 includes a discrete descriptors table 328, which lists discrete descriptor variables and their assigned drop down values along with an option to delete each drop down value. The descriptors and drop down values listed in the descriptors table 328 are for an exemplary online shoe store which, unlike the online shoe store example of FIG. 5b, employs commissions and prefers to sell high-margin products.

If the current market has a market type of “Competitive” (as established in the edit market panel 186 of FIG. 5a) and has “Market defined by administrator” chosen as a Market Behavior (as established in the market behavior panel 252 of FIG. 5b), then the market details page will become available. Furthermore, the categories field in the edit market panel 186 must be set to yes. After pressing the market details button 210, the market details panel 324 will be displayed. The market details panel 324 allows the market administrator to define a descriptor-based profile for each category. The profile includes preferred values and importance weights for each (not necessarily all) descriptors for the market. Buyers and sellers must then adequately match this profile in order to trade within the given category.

FIG. 5e shows a fifth set of software-generated panels 340 continued from FIG. 5d. The fifth set of software-generated panels 340 include a market status panel 342, a schedule market panel 344, and a transaction summary report panel 346.

The market administrator may activate a market by pressing the status button 204 after all other panels (of FIGS. 3a-3b and 5a-5e) are complete. Activating a market prepares the customizable matching system 10 of FIG. 1 to receive and clear transactions. Configuration data is exported in XML via HTTP to a client application, such as the application server 32 of FIG. 1, with details specifying what data the matching engine 28 requires for market clearing.

The Market Details page will also become available when the Transaction Type “Internal Allocation” is selected in the Edit Page, providing further configuration specific to that transaction type.

The schedule market panel 344 appears, when available, after pressing the schedule button 208 from another panel. The schedule market panel 344 includes a scheduling section 350, which includes various drop down menus for specifying the start and end dates for the market, the time zone, and beginning, ending, and clearing values for the market. In the present example, the market employs time-based clearing, wherein the market is scheduled according to a specific time preference. One skilled in the art will appreciate that a market may be cleared manually (manual clearing), by a client application, according to a specific volume preference (threshold clearing), and so on, without departing from the scope of the present invention. After a market is scheduled to clear via the schedule market panel 344, the submit button 106 appears, enabling the market to be cleared according to the specified schedule. A clear button (not shown) may also be provided to allow for manual clearing in response to the pressing of the clear button.

When the reports button 92 is pressed, the transaction summary report panel 346 is displayed. The transaction summary report panel 346 includes a market name drop down menu 352 for naming a market for which to create a report, and a categories drop down menu 354 for selecting a category for which to create a category-specific report. A clearings display section 356 displays clearing information for the named market and selected category (if any). The clearings display section 356 has a display option 358 for specifying the number of clearings to be shown per page or panel. A general summary section 360 displays general market summary information.

Various different types of market reports may be displayed via the in response to pressing the reports button 92 from a configuration panel. Market report types include configuration reports, transaction results reports, and transaction entity summaries.

The various panels and input fields of FIGS. 3a-3b and FIGS. 5a-5e activate corresponding software running on the market generation system 12 to implement various functions associated with each panel. With access to the present teachings, one skilled in the art may readily implement this software without undue experimentation. Furthermore, the software may be implemented in hardware without departing from the scope of the present invention.

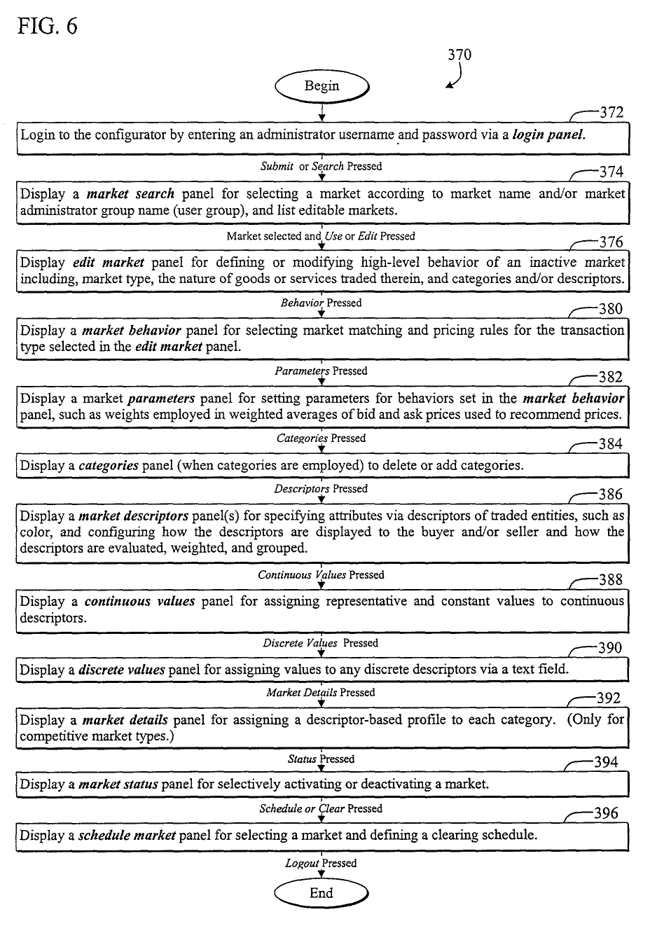

FIG. 6 is a flow diagram of a method 370 for obtaining requisite input from a market administrator via the market administrator panels of FIG. 5a-5e for use by the method of FIG. 2. In an initial market administrator login step 372, the market administrator submits an appropriate usemame and password and is logged into the system.

Subsequently, in a market search step 372, the market administrator employs a search panel to select a market according to market name or user group name. Editable markets are listed in the search panel.

Next, an edit market panel is displayed in an edit market step 376. The market administrator uses the edit market panel to define or modify high-level behavior of an inactive market. Specifying high-level behavior includes specifying market type, whether goods and/or services will be traded via the market, and whether categories and/or descriptors will be employed by the market.

Next, a market behavior panel is displayed in a market behavior step 380. The market behavior panel allows the market administrator to configure market behavior by selecting market matching and pricing rules for the transaction type selected in the edit market panel of the edit market step 376.

Subsequently, a market parameters panel is displayed in a market parameters step 382. The market parameters panel allows the market administrator to set certain parameters associated with selections in the market behavior panel of the market behavior step 380.

Next, a market descriptors panel is displayed in a market descriptors step 386. The market descriptors panel allows the market administrator to specify market attributes via descriptors (descriptor variables) associated with entities to be traded via the market. For example, the market administrator may specify shoe material and shoe traction type as descriptors. The market administrator may also specify whether the descriptor variable will be a continuous or discrete variable and the method employed to compute a score based on descriptor values and importance values associated with the descriptor variable.

Subsequently, a continuous values panel is displayed in a continuous values step 388. The continuous values panel allows the market administrator to assign dropdown values, representative values and constant values to continuous descriptor variables.

Next, a discrete values panel is displayed in a discrete values step 390. The discrete values panel allows the market administrator to assign values to any discrete descriptors via a text field.

Subsequently, in a market details panel is displayed in a market details step 392. The market details panel allows the market administrator to assign descriptor-based profiles to each category as described above.

Subsequently, a schedule market panel is displayed in a schedule market step 396. The schedule market panel allows a market administrator to schedule a market to clear.

Next, a market status panel is displayed in a market status step 394. The market status panel allows a market administrator to selectively activate or deactivate a market.

The order in which the steps 372-396 of the method 370 of FIG. 6 are performed may be altered and various steps may be omitted or skipped without departing from the scope of the present invention.

Note that although the present invention has been described with respect to specific embodiments thereof, that these embodiments are merely illustrative, and not limiting, of the invention. For example, although the invention has been described in relation to the configuration and operation of electronic commerce markets, the invention can be adapted to the creation of any transaction system where attributes and values are used to resolve the transaction. The terms “buyer” and “seller” are intended to mean any first and second persons, or items (or a mix of both), to be involved in a transaction. In general, the configuration system can create a market that resolves a desire with a “best match”. This allows, for example, one or more (e.g., a group of people with common interests) users seeking a good or service to be matched with any other user, good or services (or collections of users, goods or services) in a manner as defined by an administrator. Thus, the system can be applied in an e-commerce setting (consumers and vendors), a labor setting (workers and employers), an internal allocation setting (consultants and projects, resources and clients), or any other setting fitting the aforementioned definition.

Although the present invention has been described herein with reference to a particular embodiment for a particular application. Those having ordinary skill in the art and access to the present teachings will recognize additional modifications, applications, and embodiments within the scope thereof.

It is therefore intended by the appended claims to cover any and all such applications, modifications and embodiments within the scope of the present invention.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. An administrator interface for defining or configuring a market comprising:
a first set of instructions for allowing an administrator to name and select a market; and
a second set of instructions for allowing said administrator to configure a set of attributes in a transaction of the market.

2. The interface of claim 1 wherein said second set of instructions is configured according to said market type.

3. The interface of claim 2 wherein the market is one of a competitive market, an exchange market, a barter, a reverse auction, a consignment store, or a trading post.

4. The interface of claim 1 wherein said second set of instructions includes means for selectively associating an attribute of a product or service to be transacted via said market with a descriptor variable and means for configuring properties of said descriptor variable.

5. The interface of claim 4 wherein said means for configuring properties of said descriptor variable includes means for associating said descriptor variable with one or more importance values.

6. The interface of claim 5 further including means for adjusting a user interface of said market to enable a user to assign importance values to descriptor variables in accordance with an order by which said descriptor values are selected or entered by said user via said user interface.

7. The interface of claim 5 wherein said one or more importance values is a buyer importance value.

8. The interface of claim 5 wherein said one or more importance values is a seller importance value.

9. The interface of claim 4 wherein said means for configuring properties of said descriptor variable includes means for defining said descriptor variable as being discrete or continuous.

10. The interface of claim 4 wherein said second set of instructions further includes means for selecting an evaluation method for evaluating said descriptor variable during market operation.

11. The interface of claim 10 wherein said evaluation method includes a distance method, a more is better method, a less is better method, a strictly equal to method, a not equal to method, a less than or equal to method, and/or a greater than or equal to method.

12. The interface of claim 11 wherein said second set of instructions further includes means for selecting a type of input field associated with said descriptor variable for inclusion in a user interface associated with said market.

13. The interface of claim 12 wherein said type of input field is a text box or a drop-down menu or checkbox.

14. The interface of claim 13 wherein each menu item of said drop down menu or each input to said text box is associated with said descriptor variable, each menu item or input further associated with a descriptor value.

15. The interface of claim 14 wherein said descriptor value is associated with one or more importance values.

16. The interface of claim 15 wherein said one or more importance values includes seller and/or buyer importance values, which indicate an importance of said descriptor value associated with said descriptor variable associated with said attribute to said seller and/or buyer, respectively.

17. The interface of claim 16 in communication with a system for computing a total match score (Zᵢⱼ) based on said buyer and/or seller preferences and importance values according to the following equation:
$${Z}_{ij} = \sqrt{{Z}_{ij}^{i} {Z}_{ij}^{j}} , \qquad [ 8 ]$$
where Zᵢⱼ is a match score based on buyer importance values, and Zᵢⱼ is a match score based on seller importance values.

18. The interface of claim 14 wherein said descriptor value is associated with a continuous descriptor variable.

19. The interface of claim 1 wherein said first set of instructions includes a set of system administrator interface input panels.

20. The interface of claim 19 wherein said system administrator interface input panels include one or more input fields for naming a market to be selected or created.

21. The interface of claim 20 wherein said system administrator interface input panels further include one or more input fields for associating said market to be created with a user group of market administrators.

22. The interface of claim 21 wherein said system administrator interface input panels further include one or more input fields for associating a market administrator with said user group.

23. The interface of claim 20 wherein said system administrator interface input panels further include input fields for copying or editing an existing market configuration.

24. The interface of claim 23 wherein said system administrator interface input panels further include input fields for specifying a server and a location of data associated with said market configuration.

25. The interface of claim 1 wherein said second set of instructions includes a set of market administrator interface input panels.

26. The interface of claim 25 wherein said second set of instructions includes an input field for defining said market in terms of market type.

27. The interface of claim 26 wherein said second set of instructions includes an input field for defining said market in terms of transaction type.

28. The interface of claim 27 wherein said second set of instructions includes input fields for defining said market according to whether or not said market will transact entities that are assigned to categories.

29. The interface of claim 28 wherein said second set of instructions includes input fields for defining said market according to whether or not said market will transact entities that are assigned descriptors.

30. The interface of claim 29 wherein said second set of instructions includes input fields for defining said market according to whether or not goods and/or services will be transacted via said market.

31. A method for configuring a market or internal allocation system comprising the steps of:
employing a system administrator interface to adjust a configurator environment to accept market configuration input from a market administrator that is associated with said market;
using a market administrator interface to configure said market via said configuration input by specifying market behavior details; and
automatically integrating market configuration details, including said market behavior details, into an operational market via a market generation engine, said market generation engine in communication with said system administrator interface and said market administrator interface.

32. The method of claim 31 wherein said market behavior details specified in said step of using include market type; attributes of entities to be transacted via said market; descriptor variables to be assigned to said attributes; and importance values to be associated with said descriptor variables.

33. The method of claim 32 wherein said market behavior details further include matching criteria for matching two or more entities to be transacted via said market.

34. The method of claim 31 wherein said step of employing further includes generating market administrator accounts and market administrator user groups associated with one or more markets.

35. The method of claim 24 wherein said market generation engine includes an intelligence algorithm for recommending a market type via said market administrator interface based on remaining market behavior details and feedback from previous or current market implementations.

36. The method of claim 25 wherein said market generation engine further includes means for performing predictive market simulations according to said market behavior details.

37. A system for generating a matching-intensive website comprising:
first means for indicating products and/or services to be sold via said website;
second means for providing a list of attributes associated with said products and/or services;
third means for selectively associating weights with said attributes; and
fourth means for automatically generating an website in accordance with said products and/or services, said list of attributes, and said weights.

38. The system of claim 27 wherein said third means includes a user interface and an administrator interface in communication with a weight-mapping function.

39. The system of claim 27 wherein said fourth means includes means for selecting a type of market for use with said e-commerce site.

40. The system of claim 29 wherein said type of market is an exchange, a competitive market, a modified competitive market, a consignment store, a qualified auction, an internal allocation, and/or a futures and credit market.

41. The system of claim 27 wherein said fourth means includes means for generating a database and an accompanying matching engine for searching said database in accordance with said attributes and weights of said products and/or services.

42. The system of claim 31 wherein said matching engine includes fifth means for receiving one or more inputs; sixth means for weighting said one or more inputs and providing one or more weighted inputs in response thereto; and seventh means for accessing data in accordance with said one or more weighted inputs.

43. The system of claim 32 wherein said matching engine is a matching engine for matching products or services to a user of said engine in accordance with said one or more inputs provided by said user and/or said administrator.

44. The system of claim 33 wherein said sixth means includes one or more interfaces for specifying a continuous or discrete descriptor variable.

45. The system of claim 34 wherein said one or more interfaces includes a user interface and an administrator interface, said administrator interface including means for allowing said administrator to adjust default weights associated with said products and/or services.

46. A system for configuring an efficient matching engine comprising:
an administrator interface for selecting a market type, transaction type, whether items and/or services are to be matched, types of attributes to be associated with said items and/or services, and a first set of weights to be associated with said attributes and
a user interface for allowing one or more users to specify and rank relative preferences of said attributes.

47. The system of claim 36 wherein said efficient matching engine includes means for searching a database of said products and/or services and returning one or more matched results based on said relative preferences and said first set of preferences.

48. The system of claim 37 wherein said one or more users include a buyer and a seller.

49. The system of claim 38 wherein said user interface includes means for allowing a buyer to assign a second set of values to said attributes.

50. The system of claim 39 wherein said user interface further includes means for permitting a seller to assign a third set of values to said attributes.

51. The system of claim 40 wherein said second set of values represent default values, which are associated with said attributes when said first set of values are not provided by said buyer.

52. The system of claim 41 wherein said system further includes a means for scoring each product or service in accordance with said first set of values, said second set of values, and said third set of values associated with said attributes of said product and/or service.

53. The system of claim 42 wherein said means for scoring includes a distance method.

54. An administrator interface for creating a user interface to be used to transact electronic commerce over a network, the administrator interface comprising
instructions for allowing a human operator to define a market type and
instructions for allowing a human operator to define one or more attributes to be used in association with an item to be transacted via said market.
